(19) United States
(12) Patent Application Publication
(10) Pub. No.: US 2014/0067804 A1
(43) Pub. Date: Mar. 6, 2014

(54) WORKFLOW GENERATION SERVER AND METHOD OF GENERATING WORKFLOW

(71) Applicant: HITACHI, LTD., Tokyo (JP)

(72) Inventors: Masahiro YOSHIZAWA, Tokyo (JP); Kenji TAMURA, Tokyo (JP); Tatsuya SATO, Tokyo (JP)

(73) Assignee: HITACHI, LTD., Tokyo (JP)

(21) Appl. No.: 13/962,417

(22) Filed: Aug. 8, 2013

(30) Foreign Application Priority Data
Aug. 29, 2012 (JP) 2012-188340

(51) Int. Cl. G06F 17/30

(52) U.S. Cl. CPC G06F 17/30595
USPC 707/736

(57) ABSTRACT

There is provided a history database for recording a history of a data operation with respect to a database. A workflow generation server quantifies a relation between the multiple data operations that are recorded in that operation history. A data definition and a history of an operation schedule on data in the database are used for this quantification. Then, a workflow is generated based on a numerical value that results from the quantification. Then, the workflow generation server compares the generated workflow and workflow data in a workflow database and performs recommendation of the workflow that has to be newly defined and recommendation of an amendment to the existing workflow, based on the result of the comparison.

### BACKGROUND OF THE INVENTION

1. Field of the Invention

The present invention relates to a computing system, and particularly to a technology that supports a data management task.

2. Background Art

Because of the influence of system integration by a virtualization technology, a small number of operation managers need to manage a large number of apparatuses. Because of this, there is a growing need for a configuration management database (hereinafter referred to as CMDB) that promotes efficiency of configuration management. However, generally, CMDB does not define a workflow for operating data in a database. Therefore, it is necessary to prepare any of the following mechanisms in advance to retain the data in CMDB with high accuracy.

(1) The workflow of the data operation is defined beforehand, and the operation manager has to perform data operations according to the workflow.

(2) Software (e.g. plug-in software for CMDB) that automatically is caused to perform the data operation according to a configuration change is set up beforehand, and the operation manager has to perform the data operation through the software.

In the environment where the mechanisms described above are in place, errors in updating the data should be avoidable. However, an amount of data that has to be managed as the configuration information is increased with the introduction of a new apparatus and with the start of provision of a new service. There is a high risk that the update mistake will occur until the workflow operating such data is stabilized. Furthermore, even though the workflow is strictly determined at the time of the introduction of the new apparatus and service, the workflow that is not suitable for an actual situation tends to be ignored on the site. Because of this, unless the once-determined workflow is reviewed, there is a high likelihood that the update mistakes will occur.

There is proposed a method of generating the workflow based on the past task history in order to shorten working hours in reviewing the workflow. JP-A-2012-101088 is an invention relating to a method by which a new task procedure is generated from the task history of a medical imaging search system and a task template that is equivalent to the workflow defined beforehand. JP-A-2009-116673 is an invention relating to a method by which a procedure that has to be added or deleted is extracted as a notice procedure by comparing a model operator's exemplary log with an ordinary operator's performance log. Both methods are based on the assumption that a series of tasks are performed by one operator and the task histories can be distinguished for every task. JP-A-11-250153 is an invention relating to a method by which new rules are automatically combined from histories of tasks that are performed with a method deviating from a rule registered beforehand. The invention can support the tasks by the multiple operators by abstracting the operator, but does not assume that the histories of the multiple tasks are mixed.

Even though the methods in the well-known examples described above are applied to an update history of CMDB, the workflow with high accuracy cannot be recommended.

First, in the virtualized system, there is a case where the tasks relating to multiple requests are performed in parallel at the same time. For example, when construction of a web server for a customer A and construction of a database for a customer B are performed in parallel at the same time, the two types of histories of the data operation with respect to CMDB are present in a mixed manner. In this case, accuracy of the workflow detection is decreased in the well-known examples.

Then, if the system is of a large size, there is a case where the task relating to one request is shared among the multiple operation managers (for example, server managers and network managers). In this case, the accuracy of the workflow detection is decreased in the method in which the histories of the data operation are analyzed by each of the operation managers.

Finally, there is a case where date and time of data update in CMDB is different from date and time of configuration information update on a real-life apparatus. For example, the operation manager spends several days registering with CMDB while partly determining new VM information (an IP address and the like) and finally performs a task of constructing VM all at once. When the big gap in operation date and time occurs in this manner, the accuracy in the detection of the workflow is decreased in the well-known examples.

### SUMMARY OF THE INVENTION

An object of the present invention is to provide a workflow generation server and a method of generating a workflow, which can extract a workflow of data operations relating to an individual request with high accuracy from histories of the data operations and can shorten task time for reviewing the workflow including the data operations, in a case where the data operations relating to multiple requests are performed on one database by multiple operators.

According to an aspect of the present invention, there is provided a workflow generation server including a processing unit, in which the processing unit quantifies a relation between histories of a data operation with respect to a database as a value, based on an external key to the database, and generates a workflow that is configured from the multiple data operations, using the quantified value.

According to another aspect of the present invention, there is provided a method of generating a workflow by a workflow generation server, including recording histories of a data operation with respect to a database, and causing the workflow generation server to quantify a relation between the recorded histories of the data operation, as a value, based on an external key to the database, and to generate the workflow that is configured from the multiple data operations, using the quantified value.

That is, according to a suitable embodiment of the present invention, when a history database for recording the history of the data operations with respect to the database in the related art is prepared, and an operator operates a target data group in the database through the use of database operation software, the database or the database operation software records the operation history in the history database, and the workflow generation server quantifies the relation between the multiple data operations that are recorded in the operation history, as a value. For this quantification, the workflow generation server uses a data definition of the database and a history of an operation schedule on the data in the database. Then, a new workflow is generated based on the quantified value.

Then, the workflow generation server compares the workflow generated with the method described above and an already-registered workflow in a workflow database, and performs recommendation of the workflow that has to be newly defined and recommendation of an amendment to the existing workflow, based on the result of the comparison. The amendment to the existing workflow is addition of a task of the data operation to the workflow, deletion of the task of the data operation from the workflow, and the like. Moreover, if the method described above is applied to CMDB, the database described above corresponds to the configuration management database, the target data group corresponds to the configuration information data group, and the operator corresponds to the operation manager.

The workflow generation server according to the present invention can extract the workflow of the data operations relating to an individual request with high accuracy and can shorten the task time for providing a new definition, in a case where the data operation relating to multiple requests is performed on one database.

Furthermore, if the histories of the data operations are recorded, not only by the database operation software, but also by a workflow system, because an amendment proposal can be generated for the existing workflow, the task time for making an amendment to the workflow can also be shortened.

### BRIEF DESCRIPTION OF THE DRAWINGS

FIG. 1A is a view schematically illustrating a computing system according to a first embodiment.

FIG. 1B is a view illustrating one configuration example of a server of the computing system according to the first embodiment.

FIG. 2 is a view illustrating one example of a data definition according to the first embodiment.

FIG. 3 is a view illustrating one example of a user data according to the first embodiment.

FIG. 4 is a view illustrating one example of customer information according to the first embodiment.

FIG. 5 is a view illustrating one example of customer-VM information according to the first embodiment.

FIG. 6 is a view illustrating one example of VM information according to the first embodiment.

FIG. 7 is a view illustrating one example of a monitoring configuration according to the first embodiment.

FIG. 8 is a view illustrating one example of a firewall configuration according to the first embodiment.

FIG. 9 is a view illustrating one example of workflow data according to the first embodiment.

FIG. 10 is a view illustrating one example of node data according to the first embodiment.

FIG. 11 is a view illustrating one example of an operation history according to the first embodiment.

FIG. 12 is a view illustrating one example of an operation schedule history according to a second embodiment.

FIG. 13 is a view illustrating one example of recommendation workflow data according to the first embodiment.

FIG. 14 is a view illustrating one example of recommendation node data according to the first embodiment.

FIG. 15A is a flowchart of a workflow generation program according to the first embodiment.

FIG. 15B is a flowchart (in succession) of the a workflow generation program according to the first embodiment.

FIG. 15C is a flowchart (in succession) of the workflow generation program according to the first embodiment.

FIG. 16 is a flowchart of a workflow recommendation program according to the first and second embodiments.

FIG. 17 is a view illustrating one example of an operation history graph according to the first embodiment.

FIG. 18 is a view illustrating one example of screen display by a workflow recommendation program according to the first embodiment.

FIG. 19 is a view illustrating one example of screen display by the workflow recommendation program according to the first embodiment.

FIG. 20 is a view schematically illustrating a computing system according to the second embodiment.

FIG. 21 is a flowchart of a workflow generation program according to the second embodiment.

FIG. 22 is a view illustrating one example of an operation history graph according to the second embodiment.

### DETAILED DESCRIPTION OF THE INVENTION

Various embodiments according to the present invention are described below referring to the drawings. Moreover, in the present specification, a “relative score” means a numerical value indicating strength of a relation between two operation histories included in a pair of operation histories, that is, a value that quantifies the relation between the operation histories. Furthermore, an “operation schedule” means a prior announcement of data operation with respect to configuration information on a database.

### First Embodiment

A workflow generation server or a method of generating a workflow according to a first embodiment has a configuration in that the relation between the histories of data operations with respect to the database is quantified as a value, based on an external key to the database, and the workflow configured from the multiple data operations is generated using the value.

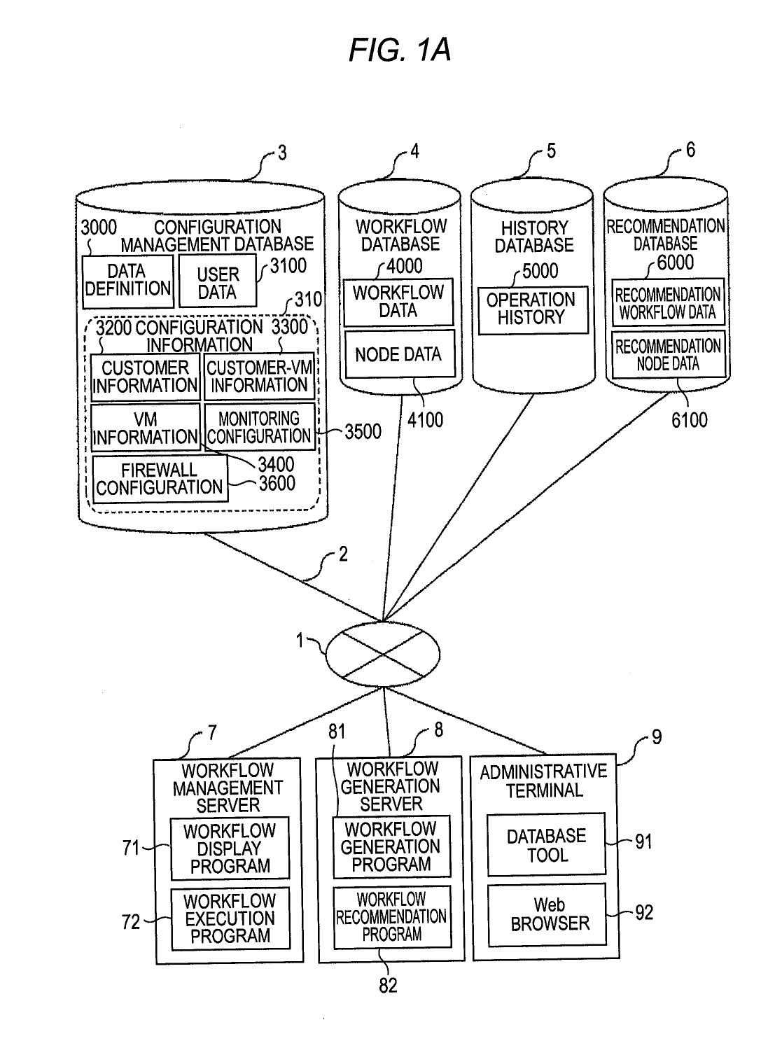

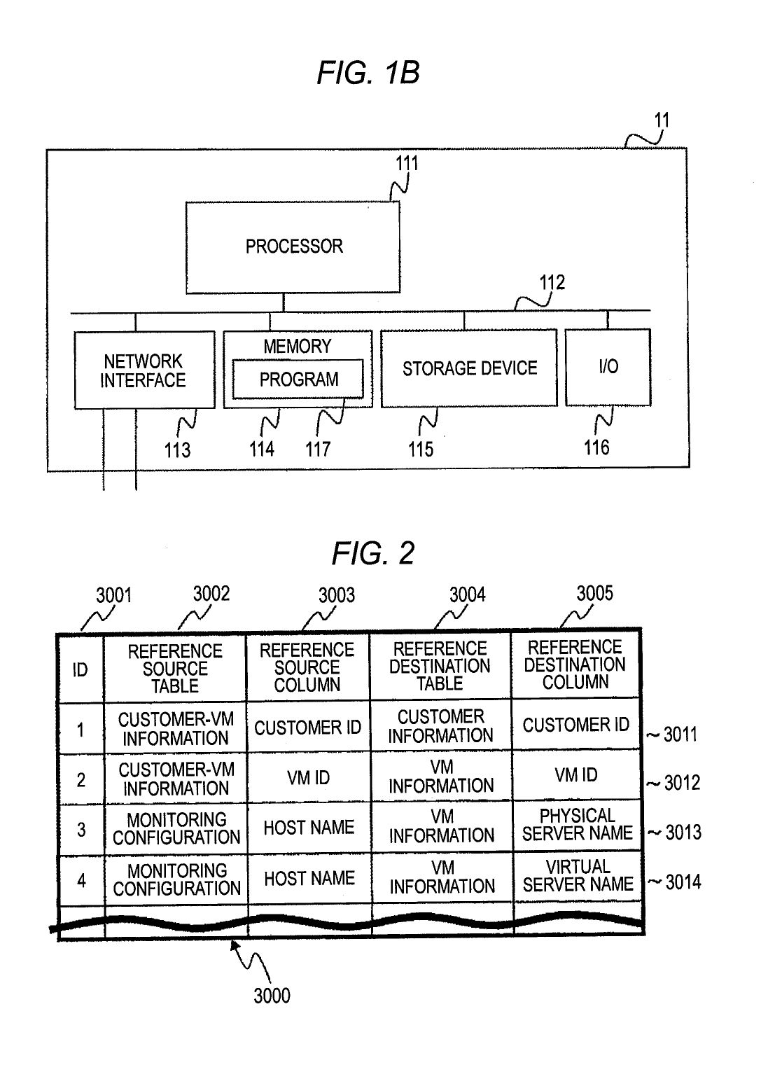

FIG. 1A schematically illustrates a computing system that is assumed according to the first embodiment. The computing system is configured to include a configuration management database 3, a workflow database 4, a history database 5, a recommendation database 6, a workflow management server 7, a workflow generation server 8, and an administrative terminal 9. These devices are connected to a management network 1 over a physical communication line 2.

FIG. 1B illustrates one example of an internal configuration of each of various servers according to the first embodiment. The workflow management server 7 and the workflow generation server 8 each have a normal computer configuration. Through a data path 112, a processor 111, configured from a central processing unit (CPU) that is a processing unit, is connected to a network interface 113 connected to the management network 1, a memory 114, which is a storage unit, a storage device 115, and an input and output (I/O) unit 116 such as a keyboard and a display device. Various programs, illustrated in FIG. 1A, are stored in the memory 114 and are executed by the processor 111, which is the CPU. The storage device 112 is illustrated inside the server 11, but may be installed outside. The storage device 112 can accumulate one part of various databases, illustrated in FIG. 1A. Moreover, it goes without saying that the administrative terminal 9 also has the same computer configuration.

The configuration management database 3 according to the present embodiment is defined as being used for configuration management of multiple physical or virtual computing systems. Furthermore, data in the configuration management database 3 is defined as being operated by multiple operation managers. The administrative terminals 9 may be present equally to the number of the operation managers.

The configuration management database 3 is a database that stores the configuration information on the multiple physical or virtual computing systems, and data necessary to manage the configuration information. As the data necessary to manage the configuration information, the database stores data definition 3000 and user data 3100. Furthermore, the configuration management database 3 according to the present embodiment stores the configuration information in the form of a table. However, the present embodiment is not limited to the data in the form of a table. For example, if, even though the data is in a tree structure, the data equivalent to the data definition, described below, is present, the present embodiment can be applied.

The data definition 3000 are data indicating a reference relation between the information items included in each configuration information. If the configuration management database 3 is a relational database management system (RDBMS), the data definition is one part of the data that are created with a CREATE TABLE command.

FIG. 2 is one example of the data definition 3000. A column 3001 is for ID for uniquely identifying the data definition. Columns 3002 and 3003 are for a name of a reference source table and a name of a reference source column. Columns 3004 and 3005 are for a name of reference destination table and a name of reference destination column. For example, a row 3011 indicates that a “customer ID” column of a “customer-VM information” table is an external key that refers to a “customer ID” column that is a main key to a “customer information” table. Moreover, the external key is an external key that is explicitly pre-defined with respect to the database.

The user data 3100 are data on a user who is allowed to operate data in the configuration management database, that is, an operation manager. The user data 3100 is created in advance by the operation manager.

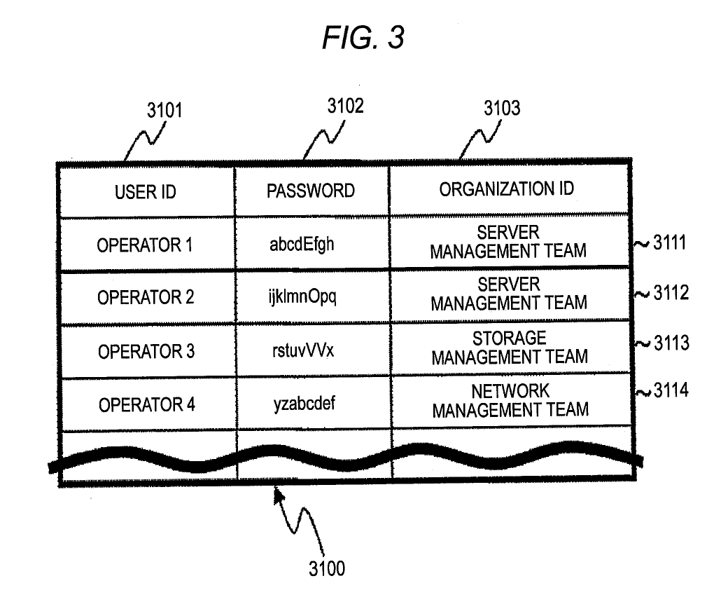

FIG. 3 is one example of the user data 3100. A column 3101 is for ID for uniquely identifying the operation manager of the system. The operation manager ID is used for access control of various data and record of the data operation history. A column 3102 is for a password used for the access control. A column 3103 is for ID of an organization to which each user belongs.

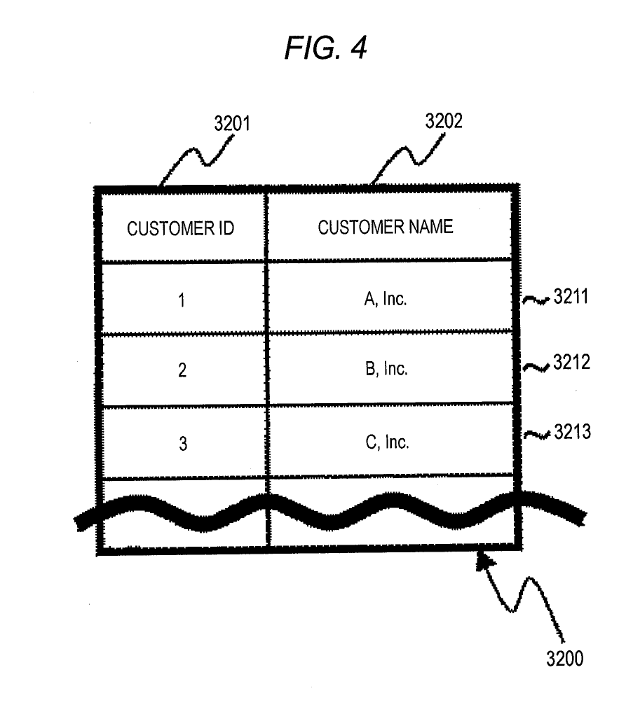

Customer information 3200 to firewall configuration 3600, which are illustrated in FIGS. 4 to 8 are configuration information according to the present embodiment. This serves as only one example of the configuration information, and the example according to the present embodiment is not limited to this example of the configuration information. The configuration information is operated by the operation manager, through a workflow execution program 72 or a database tool 91.

Furthermore, the customer information 3200 are data relating to customers that use the physical or virtual computing system.

FIG. 4 is one example of the customer information 3200. A column 3201 is for ID for uniquely identifying the customer. A column 3202 is for a name of the customer.

Customer-VM information 3300 are data that indicate a relationship between customer information and VM information.

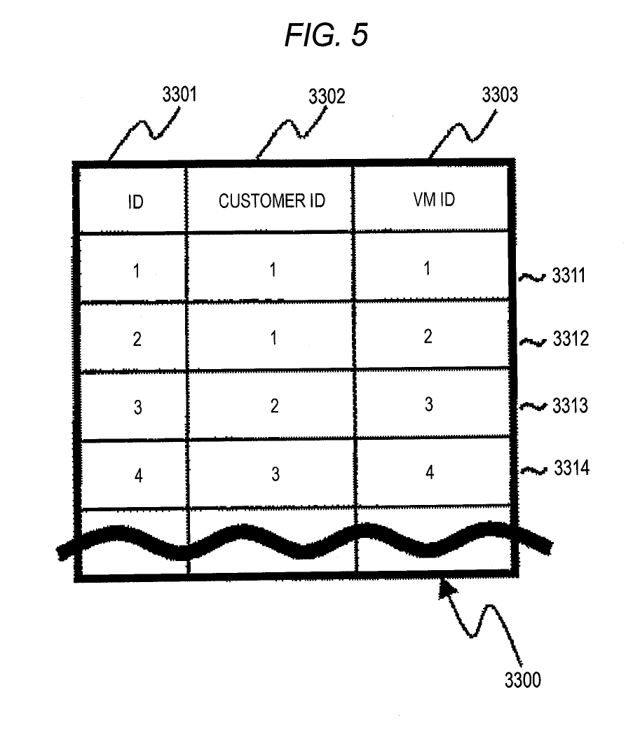

FIG. 5 is one example of the customer-VM information 3300. A column 3301 is for ID for uniquely identifying the relationship. A column 3302 is for the external key that refers to the customer information. A column 3303 is for the external key that refers to the VM information.

VM information 3400 are data relating to a virtual machine (VM) that operates on the virtual computing system.

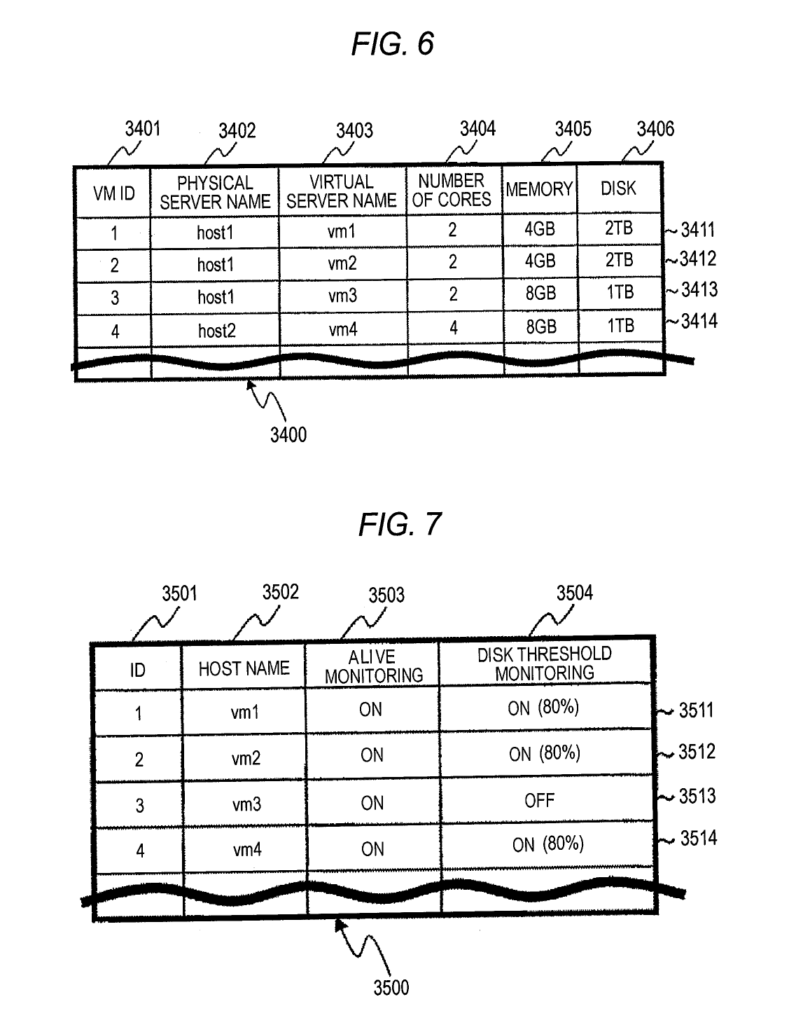

FIG. 6 is one example of the VM information 3400. A column 3401 is for ID for uniquely identifying VM. A column 3402 is for a host name of the physical machine on which VM operates. A column 3403 is for the host name of the VM. Columns 3404 to 3406 are the number of CPU cores, the size of a memory area, and the size of a disk area that the VM uses.

Monitoring configuration 3500 is data on the monitoring configuration for a physical machine or the virtual machine.

FIG. 7 is one example of monitoring configuration 3500. A column 3501 is for ID for uniquely identifying monitoring configuration. A column 3502 is for the host name of the physical machine or the virtual machine that the monitoring configuration indicates. A column 3503 is for a value for indicating the presence or absence of alive monitoring with respect to the host. A column 3504 is for a value indicating the presence or absence of disk monitoring with respect to the host and a threshold used in the disk monitoring.

Furthermore, the firewall configuration 3600 are data relating to setting of a firewall set up on the physical or virtual computing system. The customer information 3200 to the monitoring configuration 3500 are assigned a connection with any key, but only the firewall configuration 3600 is assigned a connection without a key. Because of this, according to the present embodiment, the workflow including the firewall configuration cannot be recommended with high accuracy. A countermeasure against this is described in the last portion of the present embodiment and a second embodiment.

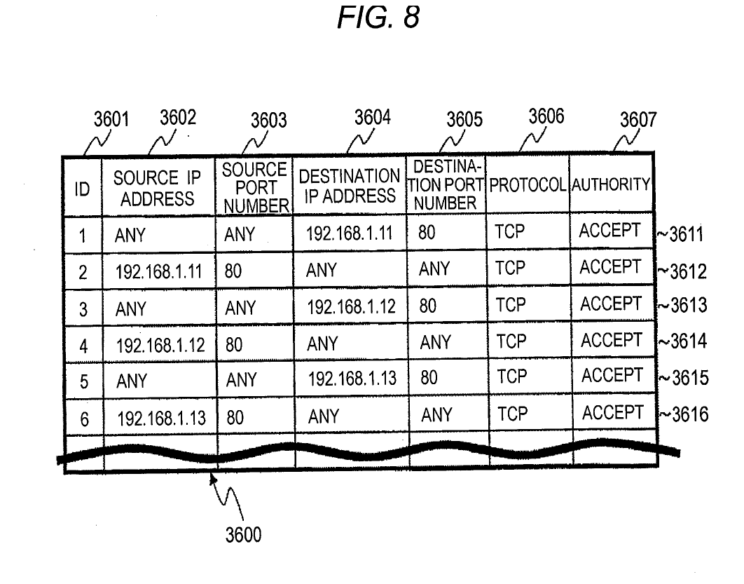

FIG. 8 is one example of the firewall configuration 3600. A column 3601 is for ID for uniquely identifying the firewall configuration. Columns 3602 to 3606 are for conditions of packets for which the setting is intended. A column 3607 is for content of processing of the packet corresponding to the condition.

The workflow database 4 is a database that stores data used by the workflow management server. The database stores workflow data 4000 and node data 4100. According to the present embodiment, a task is illustrated as a node, and the workflow is configured from the multiple nodes and a connection relationship in one direction between the nodes. The connection relationship in which the multiple nodes diverge from one node indicates task divergence or task parallelization.

The workflow data 4000 are data relating to the entire workflow.

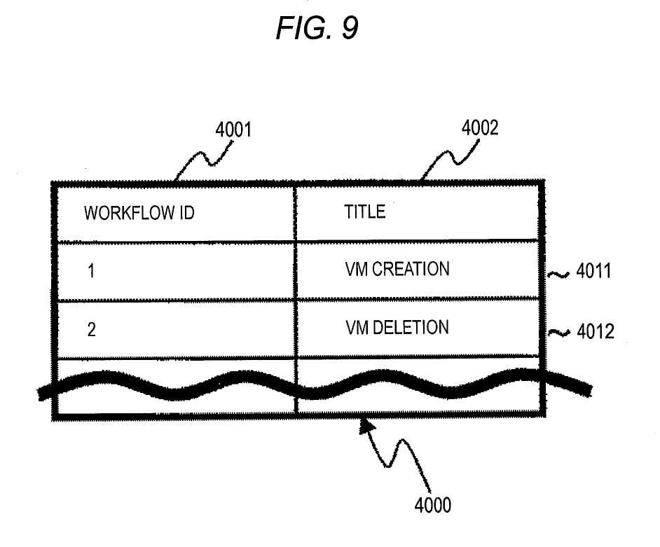

FIG. 9 is one example of the workflow data 4000. A column 4001 is for ID for uniquely identifying the workflow. A column 4002 is for a display name of the workflow. The display name is used when a workflow display program displays the workflow.

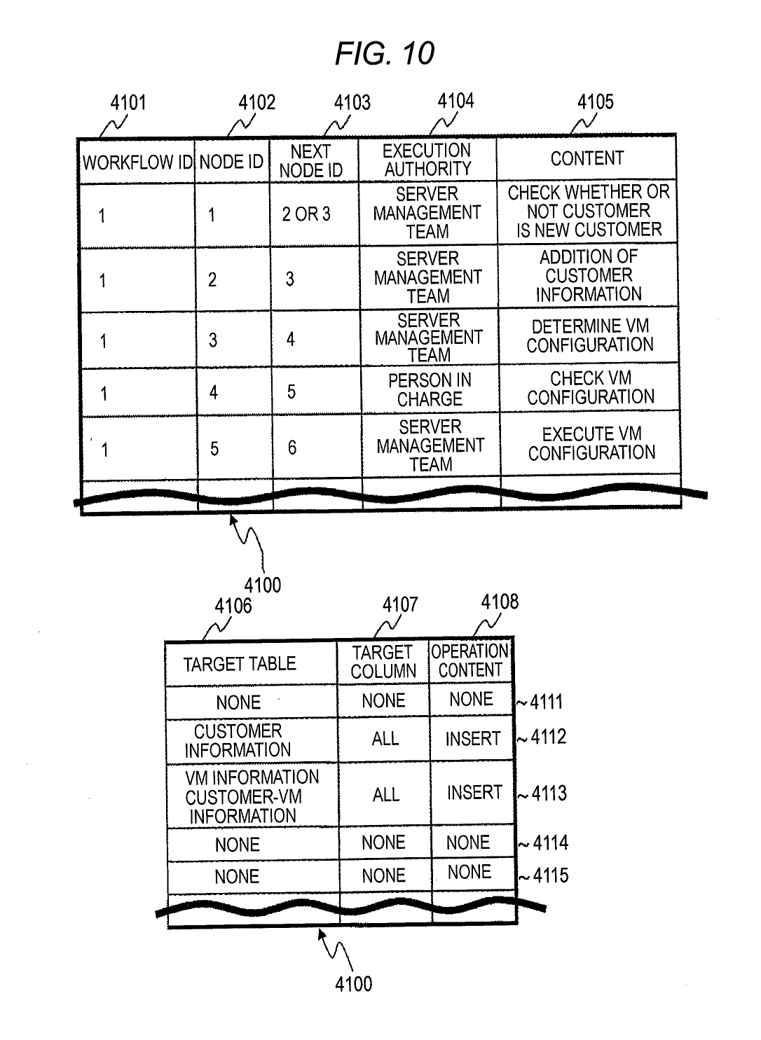

The node data 4100 are data relating to the nodes included in the workflow. The upper portion of FIG. 10 is one example of the node data 4100. A column 4101 is for ID of the workflow to which that node belongs. A column 4102 is for ID for uniquely identifying that node. A column 4103 is ID of the next node to the first mentioned node. If the task diverges out after the task indicated by that node, or if the multiple tasks are performed in parallel, the multiple node IDs are input into the column. A column 4104 is for ID of a user or an organization with execution authority over the node. A column 4105 is for content of the task that the first mentioned node indicates. Although the detail is omitted in the present embodiment, that content includes screen display that is used when the workflow display program displays that node, and processing performed by the workflow execution program.

Columns 4106 to 4108, illustrated on the lower portion of FIG. 10, are data relating to the data operation on the configuration management database, included in content of the column 4105. A column 4106 is for a table that is targeted for the data operation. A column 4107 is for a column that is targeted for the data operation. The column 4108 is for content of the data operation. The content of the data operation includes addition, update, deletion and others of the data. Furthermore, the data update falls into two categories. One is to input a value without any limitation after the update, and the other is to select the value from among candidates.

The history database 5 in FIG. 1A is a database that stores a history of the data operation with respect to the configuration information that is stored in the configuration management database 3. The database stores operation history 5000.

The operation history 5000 is a history of the data operation with respect to the configuration information. According to the present embodiment, the addition, the update, and the deletion with respect to the configuration information are handled as the data operation. However, the example according to the embodiment of the present invention is not limited to this, and access to all data may be handled as the data operation. For example, reading of data may be handled as the data operation.

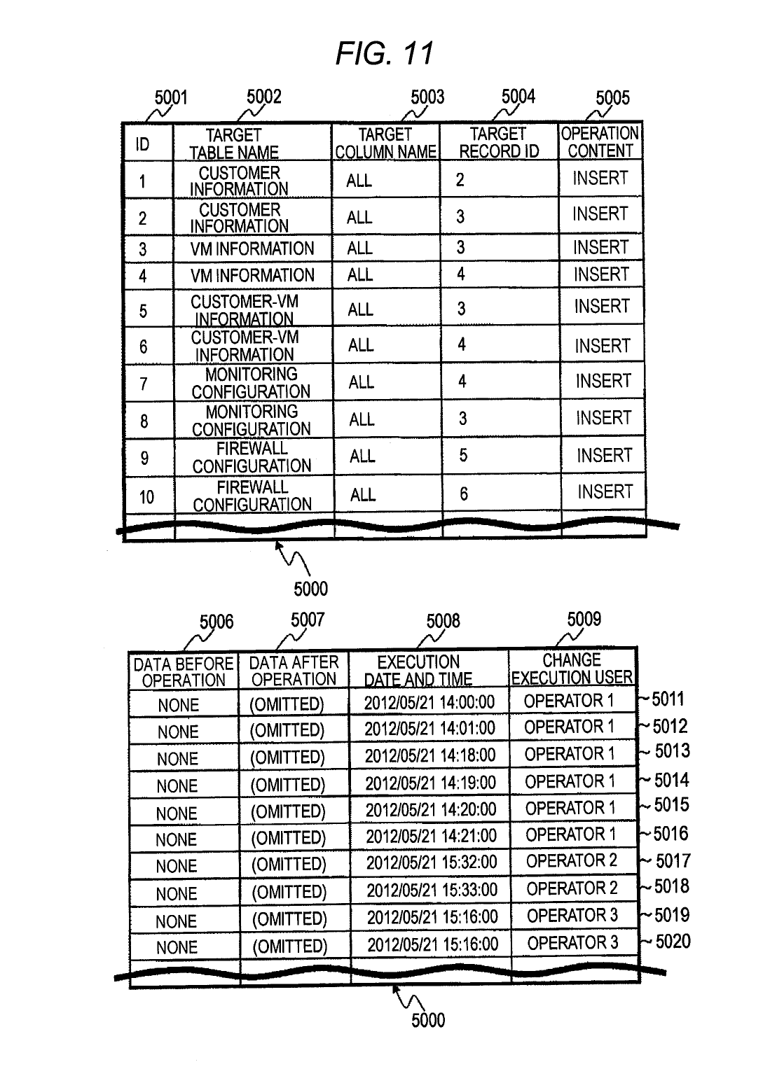

FIG. 11 is one example of the operation history 5000. A column 5001 on the upper portion of FIG. 11 is for ID for uniquely identifying the operation history. Columns 5002 and 5003 are for names of the table and the column on which the data operation is performed. A column 5004 is for a value of a main key to a record on which the data operation is performed. The multiple keys that are configured from the multiple columns, not the main key that is configured from one column, may be used, if necessary, in order to uniquely designate the record. A column 5005 is content of the data operation.

A column 5006 of the lower portion of FIG. 11 is for data that are stored in the record before performing the data operation. If the content of the data operation is “addition,” the data are not stored in that column. A column 5007 is for data that are stored in the record after performing the data operation. If the content of the data operation is “deletion,” the data are not stored in that column. A column 5008 is for execution date and time of the data operation. A column 5009 is for ID of the user who performed the data operation.

The recommendation database 6 in FIG. 1A is a database that stores the workflow created by the workflow generation program. The workflow is referred to below as a recommendation workflow in order to distinguish it from the workflow stored in the workflow database. The database stores recommendation workflow data 6000 and recommendation node data 6100. This structure is almost the same for the workflow data 4000 and the node data 4100.

The recommendation workflow data 6000 are data relating to the entire recommendation workflow.

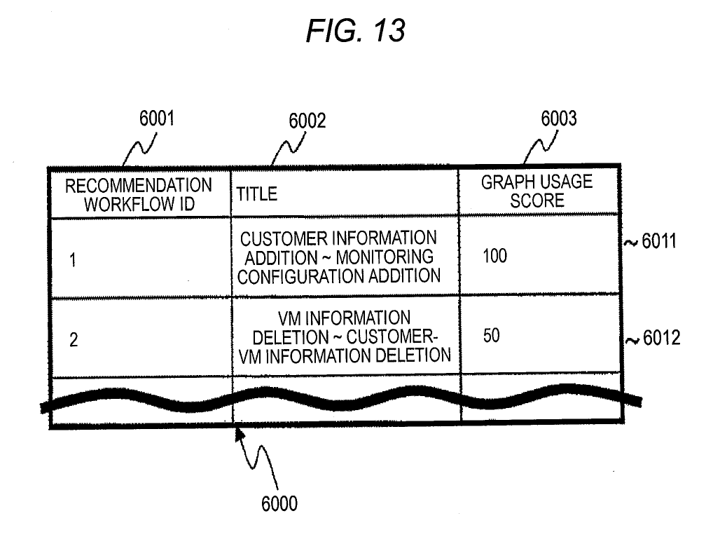

FIG. 13 is one example of the recommendation workflow data 6000. A column 6001 is for ID for uniquely identifying the recommendation workflow. A column 6002 is a proposed name of the recommendation workflow, which is created by the workflow generation program. A column 6003 is a graph usage score of the recommendation workflow, which is calculated by the workflow generation program. The graph usage score is described below.

The recommendation node data 6100 are data relating to the nodes included in the recommendation workflow. The nodes are hereinafter referred to as a recommendation node.

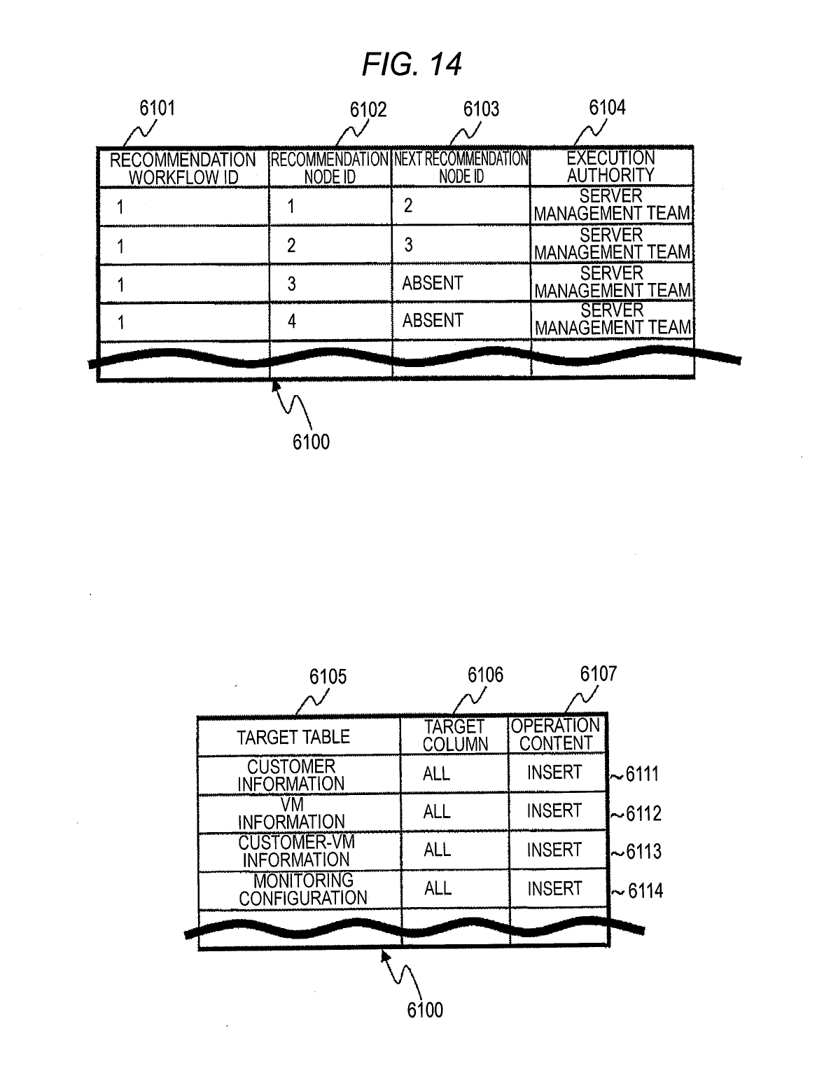

FIG. 14 is one example of the recommendation node data 6100. A column 6101 on the upper portion of FIG. 14 is for ID of the recommendation workflow to which that recommendation node belongs. A column 6102 is for ID for uniquely identifying that recommendation node. A column 6103 is ID of the next recommendation node to that recommendation node. A column 6104 is for ID of the user or organization which frequently executes that node.

Columns 6105 to 6107 on the lower portion of FIG. 14 are for data relating to the data operation on the configuration management database. A column 6105 is for a table that is targeted for the data operation. A column 6106 is for a column that is targeted for the data operation. A column 6107 is content of the data operation. The content of the data operation includes addition, update, deletion and others of the data. Furthermore, the data update falls into two categories. One is to input a value without any limitation after the update, and the other is to select the value from among candidates.

The workflow management server 7 in FIG. 1A is a server that performs display and execution of the workflow. The workflow management server 7, as illustrated in FIG. 1B, transmits and receives the packet through the network interface. Each program of the workflow management server 7 is stored in the memory, and at the time of execution of the program, the CPU which is the processing unit reads the program out through the internal data path to execute the program. The memory stores the workflow display program 71 and the workflow execution program 72.

The workflow display program 71 is a program that provides workflow data stored in the workflow database 4 in response to a request from the operation manager. According to the present embodiment, the operation manager reads the workflow data provided by the workflow display program 71 through a Web browser 92.

The workflow execution program 72 is a program that performs configuration change processing on a physical or virtual device, and performs operation on the configuration information in the configuration management database that is entailed by the configuration change processing, in response to the request from the operation manager. According to the present embodiment, the operation manager instructs the workflow execution program 72 to execute the processing, through the web browser 92. Furthermore, when operating the configuration information, the workflow execution program 72 records a history of the data operation in the history database 5. The recording is not essential in the present embodiment, but the workflow generation server can recommend an amendment to the existing workflow, by performing the recording.

The workflow generation server 8 in FIG. 1A is a server that generates the recommendation workflow. The workflow generation server 8 transmits and receives the packet through the network interface illustrated in FIG. 1B. Each program of the workflow generation server 8 is stored in the memory, and at the time of execution of the program, the CPU reads the program out through the data path to execute the program. The memory stores a workflow generation program 81 and a workflow recommendation program 82.

The workflow generation program 81 is a program that generates the recommendation workflow, in response to the request from the operation manager, or periodically.

The workflow recommendation program 82 is a program that recommends new addition of the workflow, or amendment to the existing workflow, in response to the demand from the operation manager. According to the present embodiment, the operation manager reads the result of recommendation provided by the workflow recommendation program 82 through the web browser 92.

The administrative terminal 9 in FIG. 1A is a terminal that is operated by the operation manager when using the workflow management server, the workflow generation server, and the database. The administrative terminal 9 transmits and receives the packet through the interface. Each program of the administrative terminal 9 is stored in the memory, and at the time of execution of the program, the CPU reads the program out through the data path to execute the program. The memory stores the database tool 91 and the web browser 92.

The database tool 91 is a program that provides the operation manager with a function of reading and editing the data in the configuration management database 3. When the operation manager operates the configuration information, the database tool 91 records the history of the data operation in the history database 5. The recording is essential in the present embodiment.

The web browser 92 is a program that operates as the interface for using the program which runs on the workflow management server and the workflow generation server, with the operation manager.

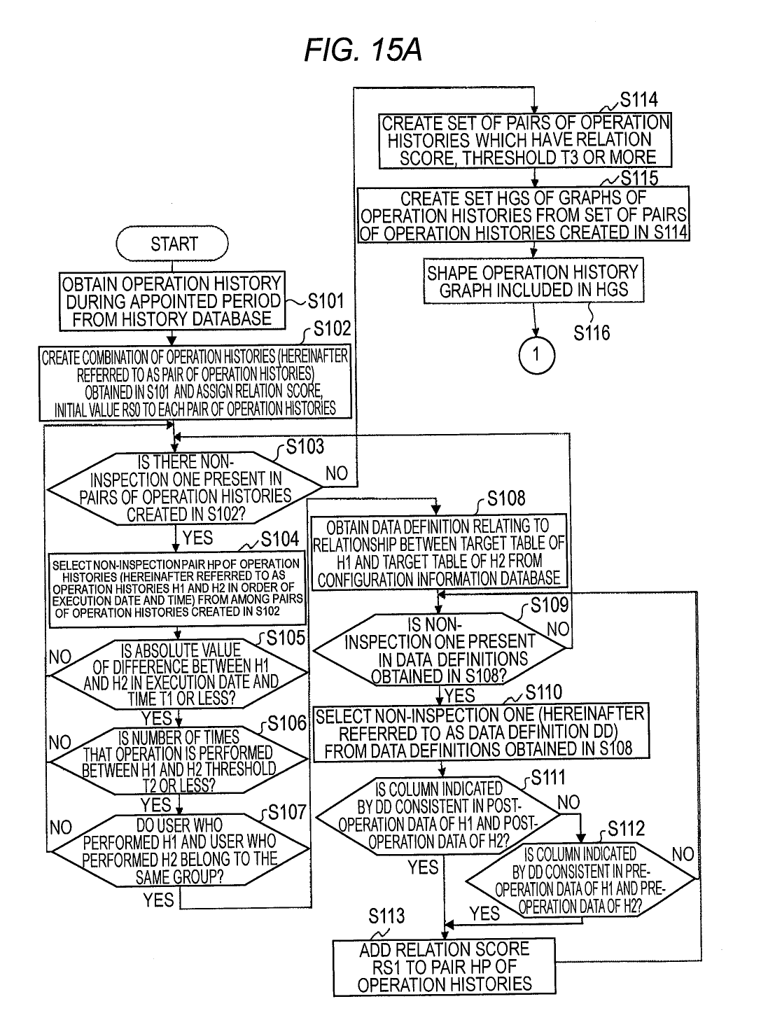

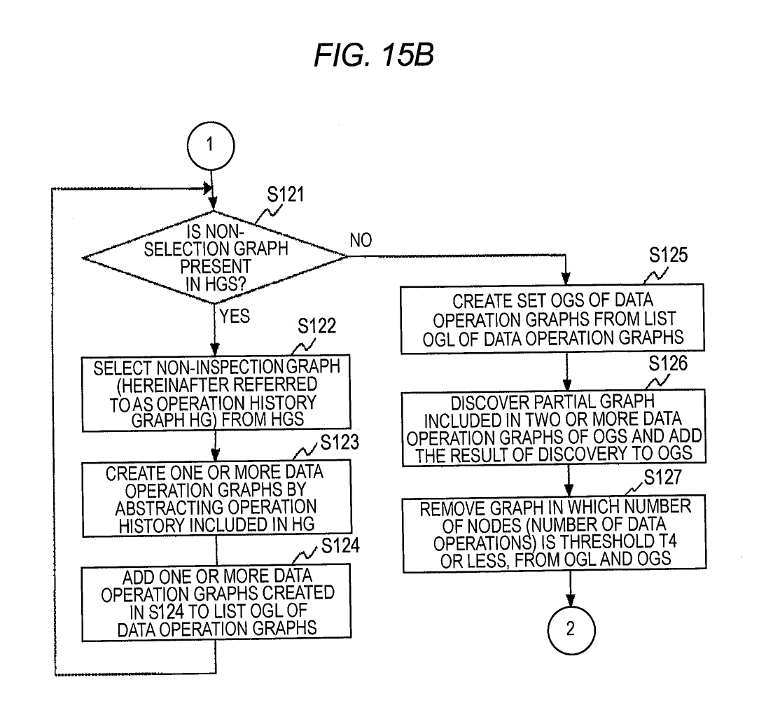

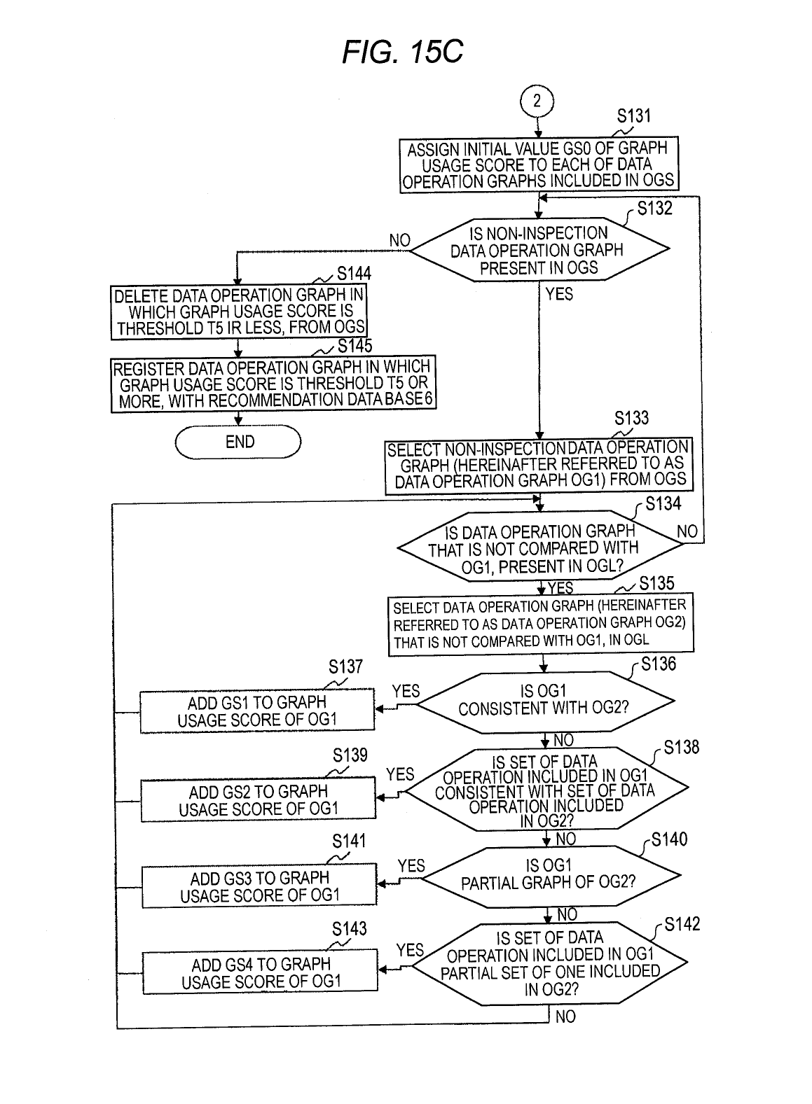

FIGS. 15A to 15C are flowcharts, each for the workflow generation program 81 to generate the recommendation workflow data. The program generates the recommendation workflow data and the recommendation node data, and stores the generated data in the recommendation database. The data are used by the workflow recommendation program 82 described below.

In the flow chart in FIG. 15A, first, the workflow generation program 81 obtains the operation history during a period appointed by the operation manager, from the history database (S101). A length of the period is determined in advance by the operation manager, depending on the operation performed on the configuration management database. For example, if it takes a maximum of 2 weeks to go through the workflow from start to finish, it is necessary to set the length of the period to 2 weeks or more.

Next, the workflow generation program 81 creates a combination of the operation histories (hereinafter referred to as the pair of operation histories) obtained in S101 (S102). Then, in subsequent S103 to S113, the numerical value, that is, the value that quantifies the relation between the operation histories (hereinafter referred to as a relation score), is calculated that indicates the strength of the relation between the two operation histories included in the pair of operation histories. According to the first embodiment, the data definition is used as information that considerably governs magnitude of the relation score that is the value that quantifies the relation between the operation histories. An initial value of the relation score, which is the value that quantifies the relation between the operation histories, is set to RS0.

First, the workflow generation program 81 selects one non-inspection pair of operation histories. The selected pair of operation histories is hereinafter referred to as HP. Furthermore, the operation histories included in HP are referred to as H1 and H2 in chronological order of execution in terms of date and time (S104). Next, the workflow generation program 81 checks a difference in execution date and time between the two operation histories, the number of different data operations performed during the time between the two operation histories, and an organization of the user who performed the two operation histories. Then, if an elapsed time between H1 and H2 is too long, H1 and H2 are excluded from the subsequent analysis (S105 to S107). The reason for doing this is to avoid generation of the workflow that is different from an actual workflow. For example, even though the two data processing with respect to the same data are present, if the two data processing are considerably different in execution date and time, there is a high likelihood that the two data processing will belong to the different workflows. That is, when quantifying the relation between the two data operation histories, the workflow generation program 81 executed by the CPU of the workflow generation server 8 can generate the workflow more accurately by referring to the difference in execution date and time between the two data operations, the number of different data operations performed during the time between the two data operations, or the organization of the user who performed the two data operations.

Next, the workflow generation program 81 obtains the data definition relating to the relation between a target table of H1 and a target table of H2 from the configuration information database (S108). Specifically, the data definition is retrieved, with a target table name and a target column name, which are included in H1, being assigned to a reference source table and a reference source column name of the data definition, and with a target table name and a target column name, which are included in H2, being assigned to a reference destination table and a reference destination column name of the data definition. Furthermore, the same search is conducted, with H1 and H2 being exchanged with respect to each other. Then, in subsequent S109 to S113, inspection is performed on each data definition (hereinafter referred to as DD) obtained in S108.

The workflow generation program 81 inspects whether the columns indicated by DD are consistent in the post-operation data of H1 and the post-operation data of H2 (S111). At this time, if either of the post-operation data shows “absent,” the columns are not considered to be consistent. At this time, if either of the post-operation data shows “absent,” it is understood from this that if both are consistent, the record is created or updated in such a manner that the post-operation data of H1 and the post-operation data of H2 are connected with the defined external key. The post-operation data may be compared, with the reference destination table and column as H1 and the reference source table and column as H2, because, if the connection is created, the data which is referred to is normally first updated. However, if the relation between the reference destination and the reference source is a cross-reference, a case may also be inspected where H1 and H2 are reversed with respect to each other.

If both are not consistent, the workflow generation program 81 inspects whether the columns indicated by DD in pre-operation data of H1 and pre-operation data of H2 are consistent (S112). At this time, if either of the pre-operation data shows “absent,” the columns are not considered to be consistent. It is understood that if both are consistent, the pre-operation data of H1 and the pre-operation data of H2 are connected with the external key, but the record is updated or deleted in such a manner as to break the connection. The post-operation data may be compared, with the reference destination table and column as H2 and the reference source table and column as H1, because, if the connection is broken, the data which refers to is normally first updated. However, if the relation between the reference destination and the reference source is the cross-reference, the case may also be inspected where H1 and H2 are reversed with respect to each other.

If the condition in either of S111 and S112 is met, the workflow generation program 81 adds a relation score RS1 to a pair HP of operation histories, and a relation score (RS0+RS1) results (S113).

When calculation of the relation score that is the value that quantifies the relation between the operation histories is completed, the workflow generation program 81 creates a set of pairs of operation histories that retain the relation score that is threshold T3 or greater (S114). Here, the reason for providing the threshold is to reduce an amount of calculation performed by the workflow generation program. Because of this, a method may be also employed in which several pairs of operation histories that are high-ranked in relation score are left behind, without imposing any limitation on the threshold.

Then, the workflow generation program 81 selects the pair of operation histories as a node (point) or an edge (line) of a graph and creates the multiple graphs (S115). The graph is hereinafter referred to as an operation history graph. With regard to the graph created at this time, all the nodes included in that graph are defined as being able to reach all the other nodes through the other nodes and edges included in that graph. Moreover, when considering reachability, a direction of the edge may be ignored. The set that includes all the operation history graphs created here is hereinafter referred to as HGS.

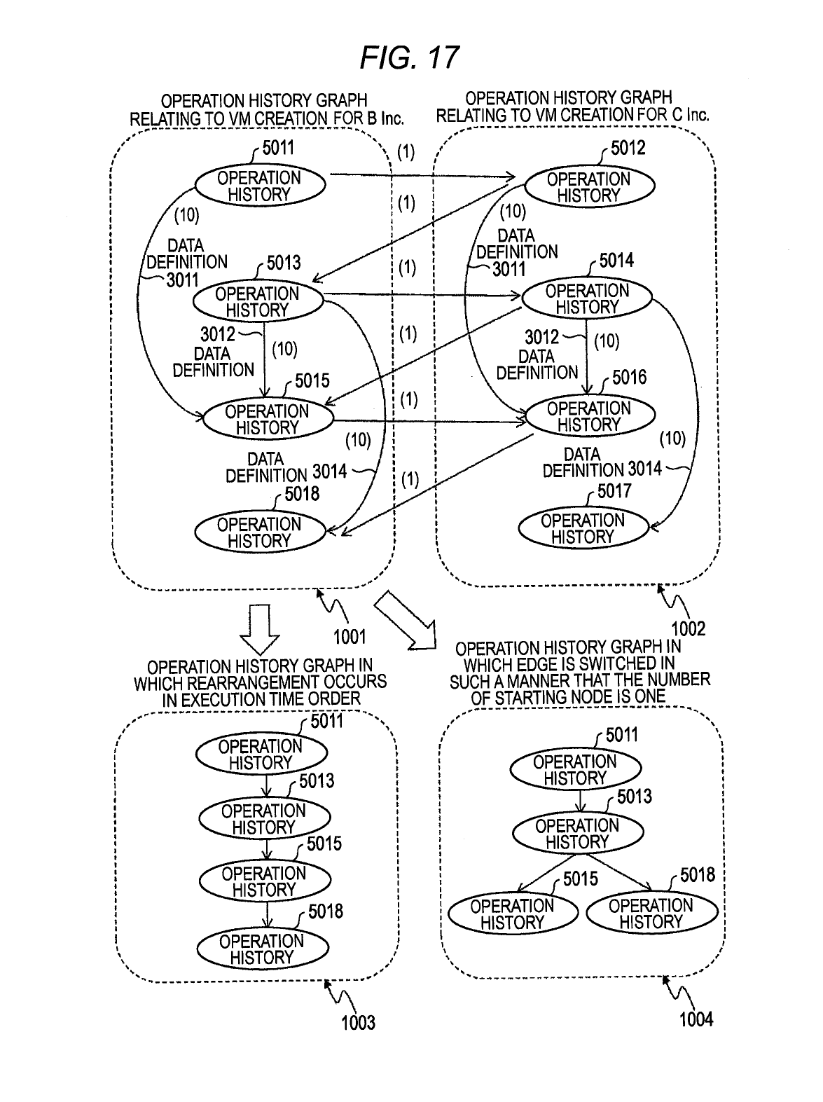

FIG. 17 is a view illustrating an example of the operation history graph according to the first embodiment. For example, two operation history graphs, that is, the operation history graph 1001 and the operation history graph 1002 are created by an operation history 5011 to an operation history 5018 in FIG. 11. The edge is defined as being unidirectional or bi-directional, according to the data definition that correlates the two operation histories included in the pair of operation histories. For example, because a data definition 3011 indicates that the reference source is “customer-VM information,” and the reference destination is “customer information,” the unidirectional edge is created that goes from the reference destination to the reference source. This is because, as the workflow, it is necessary to first create and update the data which is referred to (the data in the reference destination). Moreover, it is apparent from FIG. 17 that the numerical value in the parenthesis illustrates one example of the relation score that is the value that quantifies the relation between the operation histories.

According to the data definition in FIG. 2 and the configuration information of FIGS. 3 to 7, out of operation histories in FIG. 11, 6 pairs of operation histories (operation histories 5011 and 5015, operation histories 5013 and 5015, operation histories 5013 and 5018, operation histories 5012 and 5016, operation histories 5014 and 5016, and operation histories 5014 and 5017) include the same key. Therefore, it can be said that such pairs of operation histories are strong in relation. Therefore, a high relation score (for example, 10) is assigned to such pairs of operation histories in 5113 in FIG. 15. On the other hand, the operations performed simply in a successive manner (the operation histories 5011 and 5012, the operation histories 5012 and 5013 and so forth) are not necessarily strong in relation and the relation score is small (for example, 1). Even though the operation histories relating to the multiple requests are mixed, it is possible to extract the operation history graph in this manner by an individual's request, by quantifying the relation between the operation histories using the data definition.

Next, the workflow generation program 81 performs shaping processing on the individual operation history graph included in HGS (S116). The shaping processing refers to all the processing that changes a shape of operation history graph into a practical shape as the workflow. For example, the shaping processing includes processing that reduces the number of divergences included in the operation history graph and processing that cancels a loop that is present in the operation history graph. According to the present embodiment, the loop occurs in the operation history graph, in a case where the definition of the database is not normalized. That is, the workflow generation program 81 executed by the CPU of the workflow generation server 8 performs the processing that reduces the number of divergences included in the operation history graph in order to change the operation history graph of the workflow into the practical shape as the workflow, or performs the processing that cancels the loop included in the operation history graph in order to change the operation history graph of the workflow into the practical shape as the workflow.

As a method of reducing the number of divergences included in the operation history graph, there are present a method of exchanging the edge according to the execution date and time of the operation history (1003 in FIG. 17) and a method of replacing the edge in such a manner that the number of start node is 1. (1004 in FIG. 17).

As a method of canceling the loop that is present in the operation history graph, for example, there is a method of exchanging the edge in such a manner to line up according to the execution time, only with respect to the nodes that make up the loop. Furthermore, there is a method of deleting one part of the edge, based on the relation score. For example, there is the method of deleting the edges in decreasing order of the relation score until the loop is canceled within a range in which the node slipping out of the operation history graph does not occur.

Next, in FIG. 15B, the workflow generation program 81 performs abstraction on the individual operation history graph included in HGS (S121 to S124).

The post-abstraction operation history is hereinafter referred to as the data operation and the graph configured from the abstracted operation history is hereinafter referred to as the data operation graph.

The abstraction being mentioned here is the abstraction of an operation target value and the abstraction of an operation target column. For example, if the operation history “Update a value of an alive monitoring column to “absent” in the record of the monitoring configuration table” is present, when the operation target value is abstracted, the data operation “Update the value of the alive monitoring column of the record of the monitoring configuration table” is generated. Furthermore, when the operation target column is abstracted, the data operation “Update the record of the monitoring configuration table” is generated. Moreover, the pre-abstraction pair of operation histories is maintained as the pair of data operations. Furthermore, the information on the column that links the data operations is also maintained as information incident to the pair of data operations. The workflow generation program 81 adds all the data operation graphs generated as described above to a list of data operation graphs (hereinafter referred to as OGL) (S124).

Because the operation histories are all different, the same operation history graph is not present in HGS. However, because there is a likelihood that several data operations that are the abstracted operation histories will be consistent, there is a likelihood that the same data operation graph will be present in OGL. Therefore, the workflow generation program 81 removes redundancy of the data operation graph from OGL and creates a set of the data operation graphs (hereinafter referred to as OGS) (S125). Furthermore, the workflow generation program 81 dicovers a subgraph included in two or more data operation graphs in OGS and add the subgraph to OGS (S126). This processing is not essential and is necessary only when it is desired that the data operation that is commonly performed in the multiple workflows be extracted as the workflow. Then, the workflow generation program 81 removes the graph the number of nodes (the number of data operations) of which is threshold T4 or less, from OGL and OGS (S127). Here, the reason for providing the threshold is to reduce an amount of calculation performed by the workflow generation program.

In subsequent 5131 to 5143 illustrated in FIG. 15C, with respect to each data operation graph included in OGS, a numerical value indicating the extent to which that data operation graph is used, that is, the graph usage score illustrated in FIG. 13 is calculated. An initial value of the graph usage score is set to GS0.

Moreover, the workflow generation program 81 selects one non-inspection data operation graph from OGS (S133). The selected data operation graph is hereinafter referred to as OG1. In subsequent S134 to S143, each data operation graph included in OGL, and OGI are compared, and a value is added to the graph usage score of OG1 according to the result of the comparison.

First, the workflow generation program 81 selects the data operation graph that is not compared with OG1, from OGL (S135). Such data operation graph is hereinafter referred to as OG2. Then, if any of the following conditions is met, when comparing OG1 and OG2, a value is added to the graph usage score of OG1 (S136 to S143).

OG1 and OG2 are completely consistent with each other. A set of the data operations included in OG1 and a set of the data operations included in OG2 are completely consistent with each other.

OG1 is a subgraph of OG2. A set of data operations included in OG1 is a subset of a set of data operations included in OG2.

It is assumed that, as the extent of consistency becomes greater, the value added to the graph usage score becomes greater. That is, the following relationship is assumed to be established: GS1 GS2 GS3 GS4. However, if order of execution of the workflow (that is, whether or not the consistency is present as the graph) is considered to be important when generating the workflow, the following relationship may be possible: GS1 GS3 GS2 GS4.

Next, if the number of data operation graphs is too great, or too small that exceeds the threshold at which the data operation graph the graph usage score of which is threshold T5 or less is deleted from OGS (S144), the workflow generation program 81 may define the fixed number of data operation graphs as OGS, in increasing order of the graph usage score.

Finally, the workflow generation program 81 registers the data operation graph included in OGS with the recommendation data base 6, along with the graph usage score calculated in S133 to S143 (S145). At this time, information on all the data operation graphs is registered with the recommendation workflow data 6000, and information on the individual node included in the data operation graph is registered with the recommendation node data 6100. Moreover, at the time of the registration, the workflow generation program 81 automatically generates a name of the workflow, based on the target table, the target column, and the operation content of the recommendation node data. The name is used to show characteristics of the generated workflow to the operation manager. For example, a case is considered in which the workflow is created based on the operation history graph 1003 in FIG. 17. If only information on the start node is used, the name of the workflow is defined as “addition of customer information.” If information on the start node and an end node is used, the name of the workflow is defined as “addition of customer information to addition of monitoring configuration.” A method of using information on nodes other than the start node and the end node and a method of using the number of nodes included in the workflow may be used in addition to these methods. Which information is suitable to be used for a method varies depending on a target database.

An outline of the processing is described above in which the workflow generation program 81 generates the recommendation workflow data according to the present embodiment.

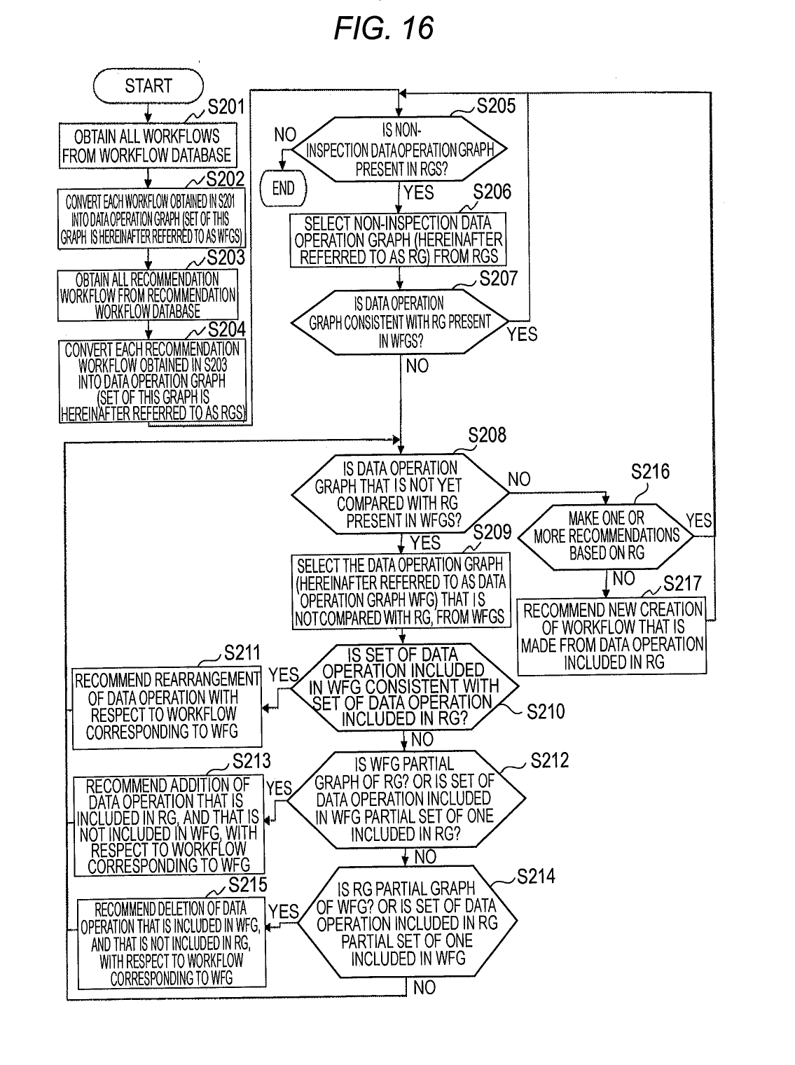

FIG. 16 is a flowchart for showing the result of the workflow recommendation program 82 recommending the workflow to the operation manager. The program compares the existing workflow with the recommendation workflow created by the workflow generation program and recommends a new workflow, based on the result of the comparison.

The workflow recommendation program 82 first obtains all the workflow data and node data from the workflow database 4 (S201). Then, the individual workflow obtained in S201 is converted into the data operation graph (S202). Because in addition to the data operation, the nodes are also included in the workflow, when the conversion to the data operation graph is performed, such nodes are excluded. For example, when the relationship that the node A is followed by the node B, followed by the node C is present in a certain workflow, if only the nodes A and C are the data operations, such workflow is converted into the data operation graph in which the node A is followed by the node C. The set of the data operation graphs that is created in this manner is hereinafter referred to as WFGS.

Next, the workflow recommendation program 82 obtains all the recommendation workflow data and recommendation node data from the recommendation database 6 (S203). Then, the individual recommendation workflow obtained in S203 is converted into the data operation graph (S204). Such a set of data operation graphs is hereinafter referred to as RGS. Then, in subsequent S205 to S217, the inspection is performed on each data operation graph (hereinafter referred to as RG) included in RGS.

First, the workflow recommendation program 82 inspects whether or not the data operation graph that is consistent with RG is included in WFGS (S207). If the data operation graph that is consistent with RG is present, because it is not necessary to perform the recommendation based on RG, returning back to S204 takes place. If the data operation graph that is consistent with RG is not included in WFGS, the data operation graph is taken out of WFGS one by one and is compared with RG (S208 to 5217). The data operation graph obtained from WFGS is hereinafter referred to as WFG.

Subsequently, the comparison between RG and WFG is performed and the processing diverges out according to the result of the comparison.

First, the workflow recommendation program 82 inspects whether or not the set of the data operations included in WFG and the set of the data operations included in RG are consistent with each other (S210). If the consistency is present, the sorting of the data operations is recommended with respect to the workflow corresponding to WFG (S211).

If the above corresponding description is not present, the workflow recommendation program 82 inspects whether or not WFG is a subgraph of RG, or whether or not the set of data operations included in WFG is the subset of the set of data operations included in RG (S212). If either condition is met, the addition of the data operation that is included in RG and thus is not included in WFG is recommended with respect to the workflow corresponding to WFG (S213).

If the above corresponding description is not present, the workflow recommendation program 82 inspects whether or not RG is a subgraph of WFG, or whether or not the set of data operations included in RG is the subset of the set of data operations included in WFG (S214). If either condition is met, the deletion of the data operation that is included in WFG and thus is not included in RG is recommended with respect to the workflow corresponding to WFG (S215).

However, even though all the WFG and RG included in WFGS are compared, there is a case where the recommendation based on RG is not performed even one time. Such a thing occurs in a case where RG is entirely different from that in the existing workflow. Therefore, in such a case, the workflow recommendation program 82 recommends a new creation of the workflow configured from the data operations included in RG (S216 to S217).

Moreover, in 5212 and 5214, if the number of nodes included in the subgraph or the subset is threshold T9 or less, this may be defined as a failure in the determination. By adding such processing, the recommendation can be made in the form of “recommendation of new creation” with respect to the recommendation workflow that has low similarity to the existing workflow.

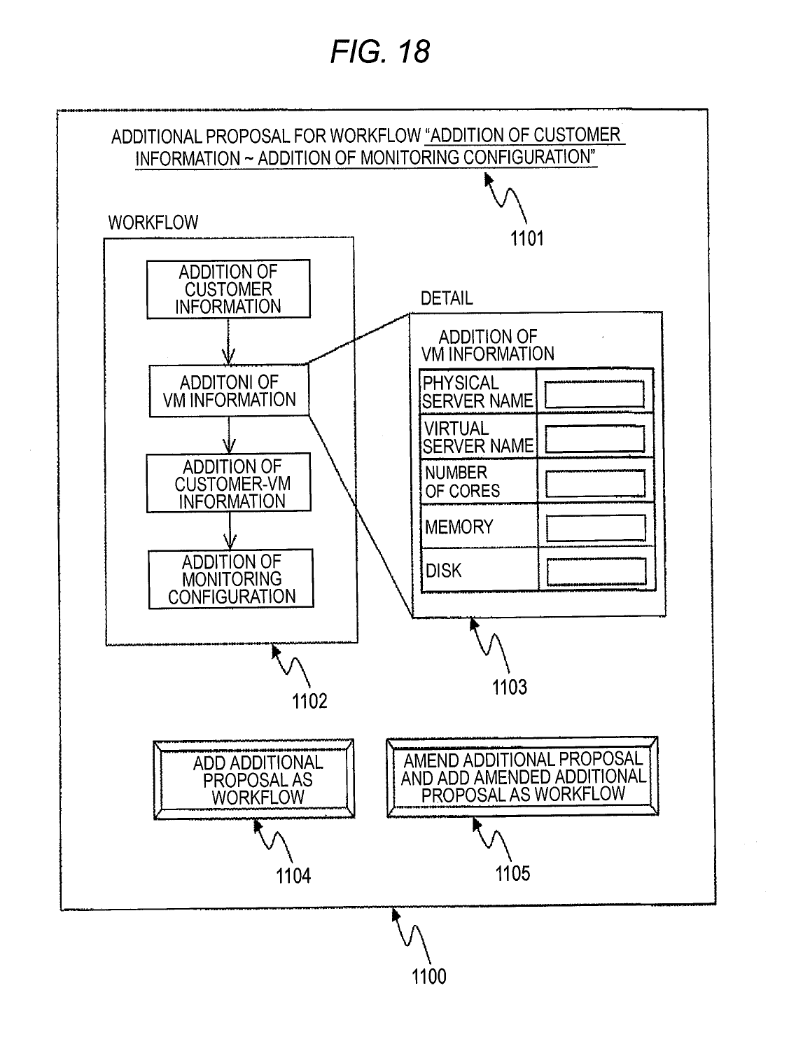

FIG. 18 is a view illustrating an example of screen display that is possible by the workflow recommendation program 82 in the case of recommending the new creation of the workflow. 1101 is a name of the workflow generated automatically by the workflow generation program. In this manner, the workflow generation server 8 can provide the user with convenience by performing presentation such as the display at the time of the recommendation of a string of automatically-generated characters with respect to the workflow.

In FIG. 18, 1102 is an entire image of the workflow, and 1103 is a detailed display of the node that is specified with the screen operation by the operation manager. The operation manager can add an additional proposal, as it is, as the same workflow by selecting a button 1104. Alternatively, the operation manager can display a workflow creation screen including the additional proposal as a default value by selecting a button 1105.

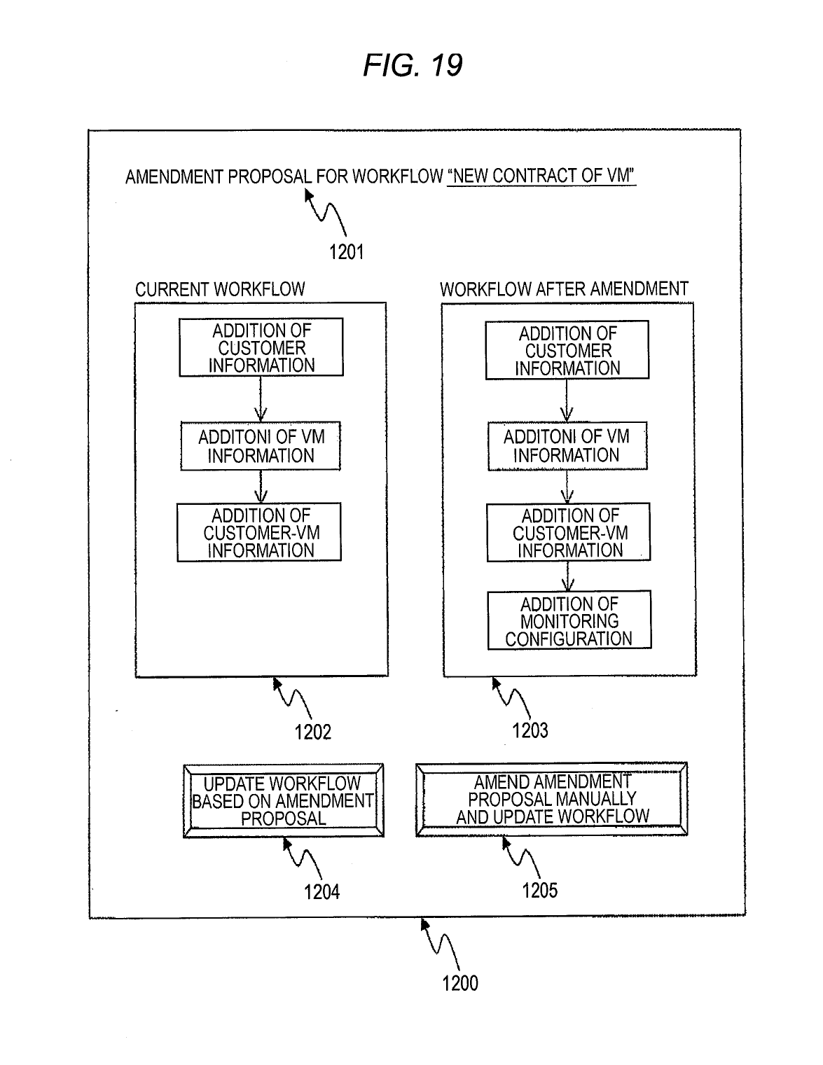

FIG. 19 is a view illustrating an example of the screen display that is possible by the workflow recommendation program in the case of recommending the addition of the data operation with respect to the existing workflow. 1201 is a name of the existing workflow for which the amendment proposal is intended. 1202 is an entire image of the workflow for which the amendment proposal is intended, and 1203 is an entire image of the workflow in the amendment proposal. The node that is common before amendment and after amendment is indicated with gray. The operation manager can make an amendment as the workflow according to the amendment proposal by selecting a button 1204. If it is desired that an amendment be made to the workflow after making an amendment to the amendment proposal to some extent, the operation manager can display a workflow edit screen including the amendment proposal as the default value by selecting a button 1205.

An outline of the processing is described above in which the workflow recommendation program 82 displays the result of recommending the workflow.

The processing in the case of the presence of the data definition is described above. However, in addition to the external key that is the data definition retained by the configuration management database 3, the workflow generation program 81 may use the data definition automatically generated by the workflow generation program, as the external key. An example of a method of automatically generating the data definition is described below. First and second methods are ones that use the configuration information actually stored, and third and fourth methods are ones that use a co-occurrence relationship between the data operations included in the existing workflow.

### First Method

All the columns in the configuration information are inspected, and sets of data included in each column are created. Moreover, the sets of data in each column are compared. If a ratio at which a set of data in a certain column A and a set of data in a column B are consistent with each other exceeds a constant value, the data definition indicating that the relationship is present between the columns A and B is automatically generated as the external key.

### Second Method

A set of results of morphologically analyzing values included in each column is created in addition to the set in the first method. Moreover, the set of the results of the morphological analysis and the set in the first method are compared. If a ratio at which the set of data in a certain column A and a set of results of morphologically analyzing data in a certain column B are consistent with each other exceeds a constant value, the data definition indicating that the relationship is present between the columns A and B is automatically generated as the external key. For example, if a rule that a value of a column “physical host name” in a table Cis “host+numerical value,” and a value of a column “virtual host name” in a table D is “host+numerical value+numerical value” is found, the data definition that the column “virtual host name” refers to the column “physical host name” is automatically generated as the external key, using this method.

### Third Method

All the workflow data and node data are inspected and the columns that are operated at the same time in one node are defined as having a relationship between them. For example, if an operation of a table A and an operation of a table B are side by side in one node, the data definition that the column in the table B refers to the column in the table A (or vice versa) is automatically generated as the external key.

### Fourth Method

All the workflow data and node data are inspected and the columns that are operated in the consecutive nodes are defined as having the relationship between them. For example, if the table A is operated in a certain node, and the table B is operated in the following node, the data definition that the column in the table B refers to the column in the table A (or vice versa) is automatically generated as the external key.

As described above, the workflow recommendation program 82 can recommend the workflow that has to be newly created, and the workflow to which the amendment has to be made and a method of making the amendment to the workflow with respect to the operation manager. Since the recommendation is performed based on the data definition, even though the data operation relating to the multiple requests is performed on the configuration management database, the accuracy of the recommended workflow is increased more than in the related art.

Because of this, there is an effect that the operation manager can quickly perform the creation and the amendment on the workflow. Furthermore, it is possible to obtain an effect that by shortening the time that it takes to create the workflow and make the amendment to the workflow, frequent review of the workflow is possible and consequently a mistake is reduced in updating the configuration management database.

### Second Embodiment

A second embodiment is described below referring to FIGS. to 22. A workflow generation server or a method of generating a workflow according to the second embodiment is characterized by employing a configuration in which the relation between the data operation histories is defined as a quantified value by using an operation schedule history that records the history of the operation schedule of the database, or a transaction processing history of the database.

According to the present embodiment, the workflow recommendation program of the workflow generation server can discover the relation from the operation schedule history, also with respect to the configuration information whose relation with other configuration information is not included in the data definition, and can increase the accuracy of the workflow being recommended more than in the related art, by performing the workflow recommendation, based on the discovered relation.

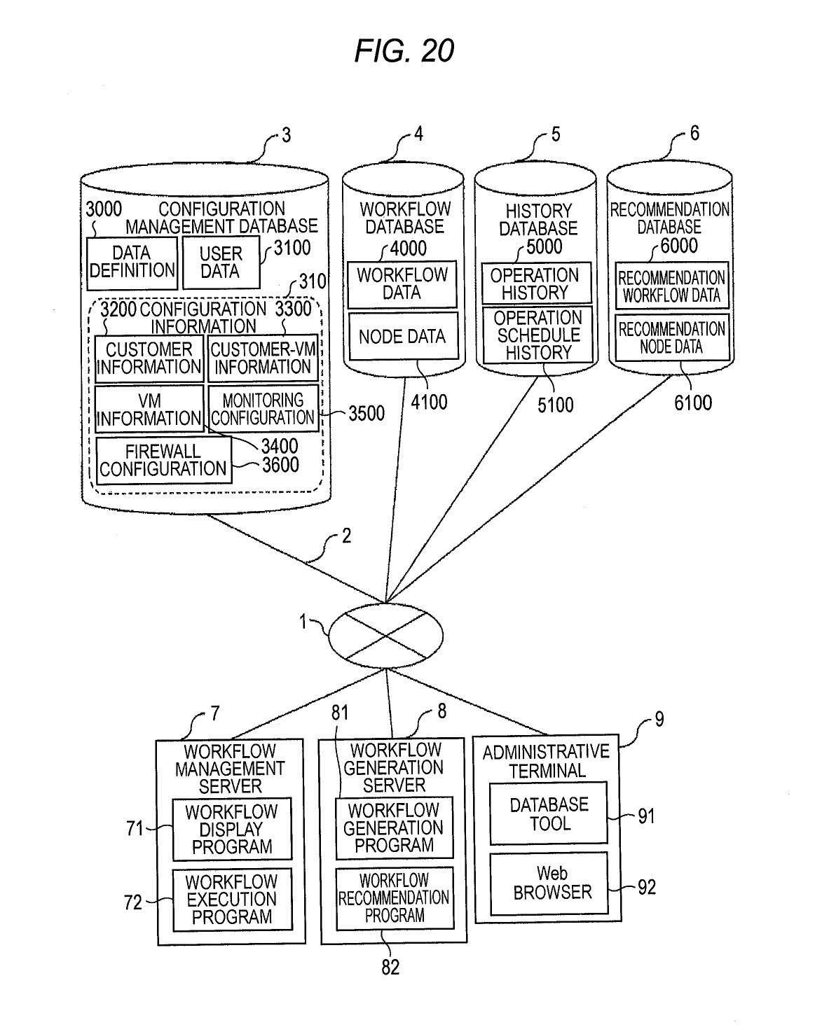

FIG. 20 schematically illustrates a computing system that is assumed according to the second embodiment. Constituent elements that make up the computing system are the same as those according to the first embodiment. However, the history database 5 according to the present embodiment stores an operation schedule history 5100 in addition to the data stored in the history database according to the first embodiment.

According to the present embodiment, prior announcement of the data operation with respect to the configuration information is referred to as an operation schedule. The operation schedule is data that indicates which configuration information is updated to which value. The operation manager shares the operation schedule relating to the data operation with other operation managers, in advance, in order to prevent the data operation performed by him/her from colliding with the data operation performed by other operation managers. According to the present embodiment, the history relating to the operation schedule is used to improve the accuracy of recommendation data flow. The history relating to the operation schedule is hereinafter referred to as an operation schedule history.

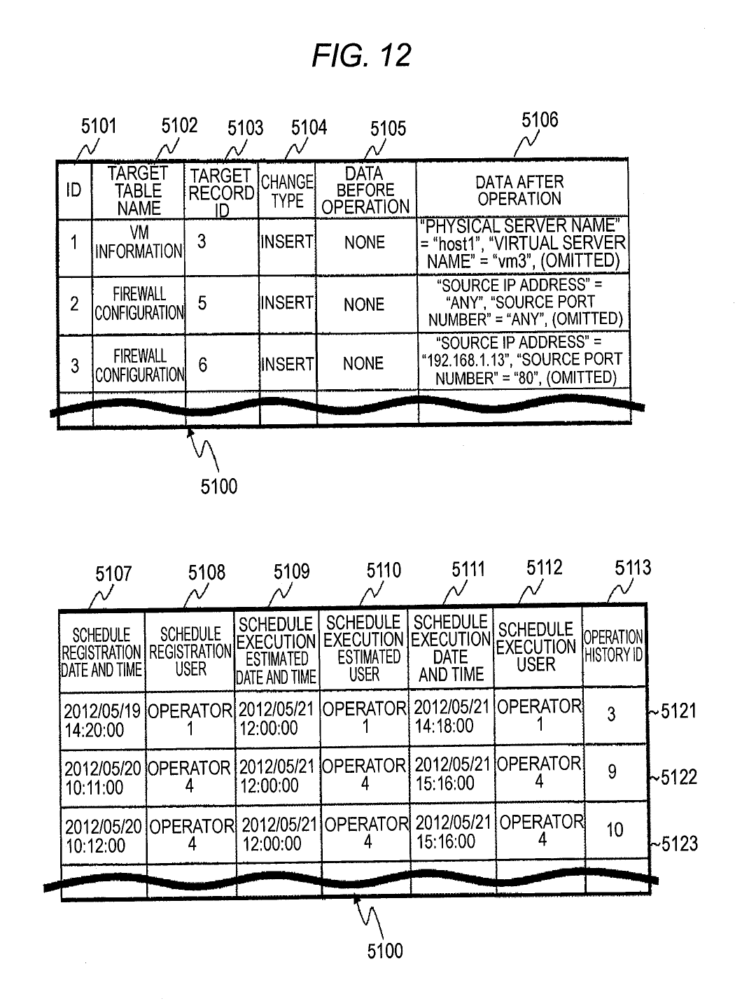

FIG. 12 is a view illustrating one example of an operation schedule history 5100. A column 5101 on the upper portion of FIG. 12 is for ID for uniquely identifying the operation schedule history. Columns 5102 and 5103 are for names of the table and the column the data operation of which is announced beforehand. A column 5104 is for a type of data operation announced beforehand. A column 5105 is for content of the record before performing the data operation announced beforehand. A column 5106 is for content of the record after performing the data operation announced beforehand.

A column 5107 on the lower portion of FIG. 12 is for date and time when such operation schedule is added to the operation schedule history 5100. A column 5108 is for a user who adds the operation schedule to the operation schedule history 5100. A column 5109 is for date and time when the beforehand-announced data operation is scheduled to be actually performed, at the time when such operation schedule is added. A column 5110 is for ID of the user who has a plan to actually perform the beforehand-announced data operation, at the time when such operation schedule is added. A column 5111 is for date and time when the beforehand-announced data operation is actually performed. A column 5112 is for ID of the user who actually performs the beforehand-announced data operation. A column 5113 is for ID of the operation history that is recorded when the beforehand-announced data operation is actually performed.

The operation schedule history 5100 is created or updated by the database tool 91 or the workflow execution program 72. When the operation manager performs the operation schedule through the programs, the new operation schedule history is added to the operation schedule history 5100. Values in columns 5101 to 5110 are input to the operation schedule history that is added at this time. Then, when the operation manager actually performs the data operation, based on such operation schedule history, the operation history relating to such data operation is registered with an operation schedule 5000, and thus values in columns 5111 to 5113 of such operation schedule history are input.

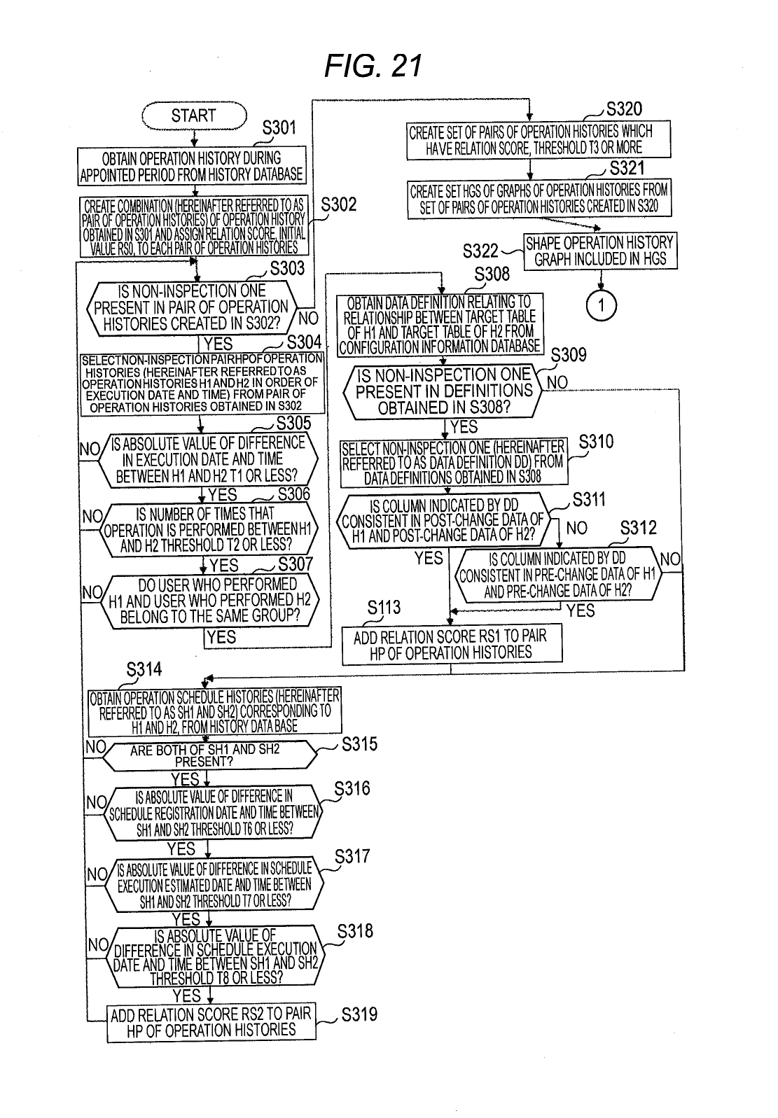

FIG. 21 is a flowchart for the workflow generation program 81 according to the second embodiment to generate the recommendation workflow data.

The workflow generation program 81 according to the second embodiment uses the operation schedule history in addition to the data definition, in order to calculate the relation score that is the value that results from quantifying the relation between the operation histories. Because of this, processing S301 to S313 in which the relation score is calculated using the data definition are almost the same as the processing S101 to S113 according to the first embodiment. However, after performing inspection on the data definition, the workflow generation program 81 according to the second embodiment proceeds to processing S314 and subsequent processing step in which the relation score is calculated using the operation schedule history.

First, the workflow generation program 81 obtains the operation schedule history corresponding to H1 (hereinafter referred to as SH1) and the operation schedule history corresponding to H2 (hereinafter referred to as SH2) (S314). The operation schedule history corresponding to H1 is the operation schedule history in which the column 5112 is consistent with the column 5001 in H1. If the operation schedule history is not present in either of H1 and H2, proceeding to inspection of the next pair of operation histories takes place (S315). If the operation schedule history is present in both H1 and H2, a difference in date and time of schedule registration between the two operation schedule histories, a difference in estimated date and time of schedule execution, and a difference in date and time of schedule execution are inspected (S316 to S318). The reason for doing this is to avoid the generation of the workflow that is different from the actual workflow.

If the inspection results in the pass, relation score RS2 is added to the pair HP of operation histories (S319). Moreover, based on the difference in date and time inspected in S316 to S318, the difference may be added to the relation score that is added here. By causing the difference in the relation score, for example, if the sets of pairs of operation histories created in S320 described below are too many, the refinement of the pair of operation histories is possible.

When the calculation of the relation score is completed, the workflow generation program 81 creates the set of pairs of operation histories that retain a relation score of threshold T3 or more (S320). Such processing is the same as S114 according to the first embodiment. Then, the workflow generation program 81 selects the pair of operation histories as the node (point) or the edge (line) on a graph and creates the multiple operation history graphs (S321).

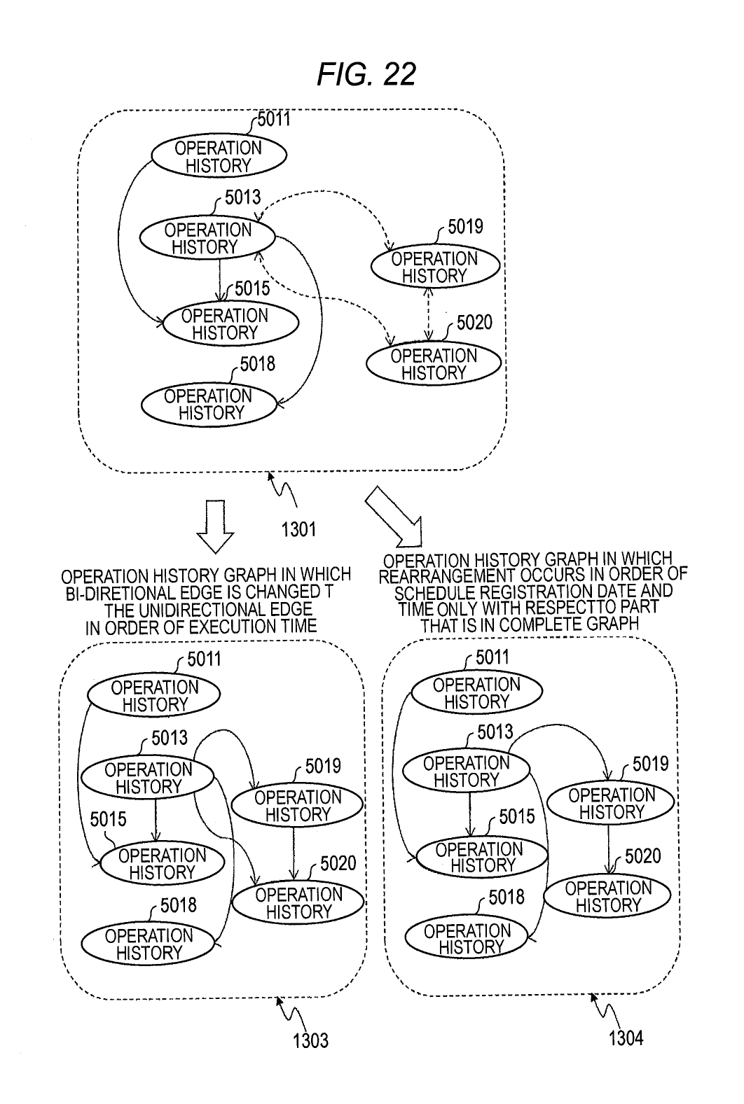

FIG. 22 is a view illustrating an example of the operation history graph according to the second embodiment. For example, the two operation history graphs are created by the operation history 5011 to the operation history 5020 in FIG. 11. 1301 in FIG. 22 is one of the two operation history graphs. Because the edge between the nodes correlated based on the operation schedule history does not include the information on the direction like the data definition, the edge is defined as being bi-directional. For example, because the operation histories 5013, 5019, and 5020 are almost at the same time in terms of estimated date and time of the schedule execution, the bi-directional edge is created between the operation histories. Moreover, in FIG. 22, the relation scores of the relations indicated by a solid line arrow are all RS0+RS1, and the relation scores of the relations indicated by a dashed line arrow are all RS0+RS2.

Next, the workflow generation program 81 performs the shaping processing on the individual operation history graph included in HGS (S121). The bi-directional edge is easier to occur in the second embodiment than in the first embodiment. As the method of canceling the loop present in the operation history graph, for example, there are a method in which the bi-directional edge is changed to the unidirectional edge according to order of date and time data (schedule registration date and time, estimated date and time of schedule execution, or schedule execution date and time) included in the operation schedule history (1303 in FIG. 22) and a method in which the node is sorted in order of date and time data as far as the part is a complete graph. After converting the bi-directional edge into the unidirectional edge using the methods, the shaping processing described according to the first embodiment is applicable. The subsequent processing by the workflow generation program 81 is the same as the processing S121 and subsequent processing step by the workflow generation program according to the first embodiment.

As described above, the workflow recommendation program 82 can discover the relation from the operation schedule history, also with respect to the configuration information whose relation with other configuration information is not included in the data definition. The accuracy of the workflow being recommended is increased more than in the related art, by performing the workflow recommendation, based on the discovered relation.

Furthermore, if the data operation in the database is performed as the transaction processing, the information relating to the transaction processing may be substituted for the schedule operation history. For example, with regard to the multiple data operations that are performed with the same transaction processing, the database tool 91 creates the operation schedule history in which values in the columns from the schedule registration date and time (the column 5107) to the schedule execution user (the column 5112) are the same. The use of such method lowers the accuracy, when compared with the case where the operation manager explicitly creates the schedule, but makes it possible to discover the relationship between the items of configuration information without depending on the data definition.

The embodiments according to the present invention are described above in detail referring to the drawings, but the specific configuration is not limited to the embodiments and includes a design and the like within a scope not deviating from a gist of the present invention. For example, the embodiments described above are described in detail in order to provide a better understanding of the present invention, but the present invention is not necessarily limited to including the entire configuration as described above.

Furthermore, one part of a configuration of a certain embodiment can be replaced with a configuration of a different embodiment, and furthermore, a configuration of a different embodiment can be added to a configuration of a certain embodiment. Furthermore, one part of a configuration of each embodiment can be added to or replaced with a different configuration, or can be deleted.

Furthermore, each configuration, function, processing unit and the like are described above with the focus placed on the case where they are realized with software, for example, by writing a program that realizes some of, or all of, them, but they may be realized with hardware, for example, by designing them into an integrated circuit.

What is claimed is:

1. A workflow generation server including a processing unit,
wherein the processing unit quantifies a relation between histories of a data operation with respect to a database, as a value, based on an foreign key defined in the database, and generates a workflow that is configured from the multiple data operations, using the quantified value.

2. The workflow generation server according to claim 1,
wherein the processing unit compares an already-registered workflow and the generated workflow, and recommends addition of the generated workflow depending on the result of the comparison.

3. The workflow generation server according to claim 1,
wherein the processing unit compares an already-registered workflow and the generated workflow, and recommends an amendment to the already-registered workflow depending on the result of the comparison.

4. The workflow generation server according to claim 1,
wherein the processing unit compares a workflow that is created by extracting only workflow nodes from an already-registered workflow and the generated workflow as a graph.

5. The workflow generation server according to claim 1,
wherein the processing unit compares what results from extracting only a node relating to the data operation from an already-registered workflow and the generated workflow as a set.

6. The workflow generation server according to claim 1,
wherein the processing unit automatically generates a virtual foreign key in addition to the pre-defined foreign key in the database.

7. The workflow generation server according to claim 6,
wherein the processing unit automatically generates a virtual foreign key between data to which a data operation is performed at the same time in an already-registered workflow.

8. The workflow generation server according to claim 1,
wherein the processing unit automatically generates a string of characters indicating characteristics of the workflow when generating the workflow, and presents the string of characters as well when recommending the workflow.

9. The workflow generation server according to claim 1,
wherein, when quantifying the relation between the histories of the data operation, the processing unit refers to a difference in execution date and time between the two data operations, the number of different data operations that are performed during the time between the two data operations, or an organization of a user who performs the two data operations.

10. The workflow generation server according to claim 1,
wherein, in order to define the workflow as an operation history graph and change the operation history graph into a practical shape as the workflow, the processing unit reduces the number of divergences included in the operation history graph.

11. The workflow generation server according to claim 1,
wherein, in order to define the workflow as a operation history graph and change the operation history graph into a practical shape as the workflow, the processing unit cancels a loop included in the operation history graph.

12. The workflow generation server according to claim 1,
wherein, by using an operation schedule history that is a history of an operation schedule on data in the database, the processing unit quantifies the relation between the histories of the data operation and thus defines the relation as the quantified value.

13. The workflow generation server according to claim 1,
wherein, by using a history of transaction processing of the database, the processing unit quantifies the relation between the histories of the data operation and thus defines the relation as the quantified value.

14. A method of generating a workflow by a workflow generation server, comprising:
recording histories of a data operation to a database; and
causing the workflow generation server to quantify a relation between the recorded histories of the data operation, as a value, based on an foreign key defined in the database, and to generate the workflow that is configured from the multiple data operations, using the quantified value.

15. The method of generating a workflow, according to claim 14, further comprising:
causing the workflow generation server to additionally record a history of an operation schedule on data in the database and quantify the relation between the histories of the data operation, using the history of the operation schedule, and to define the relation as the quantified value.
